(19) United States
(12) Patent Application Publication
(10) Pub. No.: US 2012/0044159 A1
(43) Pub. Date: Feb. 23, 2012

(54) TOUCH SCREEN PALM-TYPE DATA PROCESSING DEVICE

(75) Inventors: Jui-Ching Yang, Taipei County (TW); Ching-Feng Hsieh, Taipei (TW)

(73) Assignee: ASKEY COMPUTER CORPORATION, Taipei (TW)

(21) Appl. No.: 12/956,531

(22) Filed: Nov. 30, 2010

(30) Foreign Application Priority Data
Aug. 19, 2010 (TW) 099127694

(51) Int. Cl. G06F 3/041

(52) U.S. Cl. 345/173

(57) ABSTRACT

A touch screen palm-type data processing device includes a microprocessor; a memory electrically connected to the microprocessor for storing operation programs and function programs, the operation programs, when executed by the microprocessor, displaying a preset keyboard configuration for a user to input data thereon, and the function programs, when executed by the microprocessor, providing a processing functions; a function display unit electrically connected to the microprocessor for displaying a processing function picture after the microprocessor executes the function programs; and a key switch touch control display unit electrically connected to the microprocessor for displaying a preset keyboard configuration after the microprocessor executes the operation programs, thereby eliminating the need to design varied molds for fitting various keyboard configurations and physical keyboards for displaying varied symbols due to different languages and thus reducing the costs for manufacturing and maintaining inventory stock.

### BACKGROUND OF THE INVENTION

1. Field of the Invention

This invention relates to palm-type data processing devices, and, more particularly, to a touch screen palm-type data processing device.

2. Description of Related Art

Along with the rapid development of science technology and the electronics industry, palm-type data processing devices, such as personal digital assistants (PDAs), global positioning system (GPS) receivers and hand held computers, are more and more popular. Due to portability and an abundance of functions, palm-type data processing devices are becoming one of the most indispensable electronic products in the market.

Modern palm-type data processing devices are divided into three categories: candy-bar, clamshell and slide. A general candy-bar palm-type data processing device comprises a liquid crystal display in cooperation with a plurality of mechanical keys, both accessible on one rectangular face of the device. The mechanical keys may have different keyboard configurations, including numeric-type keyboards and QWERTY-type keyboards.

In order to satisfy various input function requirements, a palm-type data processing device is designed to have a specific keyboard configuration of mechanical keys. Accordingly, a palm-type data processing device has to further comprise a dedicated key set, housing mold, and application software executable by a key control chip that controls the mechanical keys, adding to the cost of such a palm-type data processing device.

A QWERTY keyboard may be in the form of a Chinese version (Hanyu Pinyin/Zhuyin Fuhao), Korean version, Japanese version, Germany version, Arabic version, English version, and so on, and, thus, may also have a variety of keyboard configurations. Two QWERTY keyboards of different language versions are not interchangeable. Therefore, the manufacturer often has to carry much stock for the various keyboard configurations of keyboards.

### SUMMARY OF THE INVENTION

In view of the above-mentioned problems of the prior art, it is a primary objective of the present invention to provide a touch screen palm-type data processing device that does not need to employ physical keys of different display symbols requiring different design molds to accommodate different languages.

In order to achieve the above objective and other related objectives, the present invention provides a touch screen palm-type data processing device that includes: a microprocessor; a memory electrically connected to the microprocessor and stored with an operation program and a function program, the operation program, when executed by the microprocessor, displaying a keyboard configuration for a user to input data thereon, the function program, when executed by the microprocessor, providing a processing function; a function display unit electrically connected to the microprocessor and used for displaying a processing function picture after the microprocessor executes the function program; and a key touch control display unit electrically connected to the microprocessor and used for displaying a keyboard configuration after the microprocessor executes the operation program.

The following physical configurations exist: the function display unit and the key touch control display unit are contained in a single touch control display; the function display unit and the key touch control display unit are contained in two touch control displays, respectively; and, the function display unit is contained in a screen, and the key touch control display unit is contained in a touch control display.

The touch screen palm-type data processing device provides users with keyboard configurations of an input operation that the users desire to execute according to the operation program that are used for displaying the keyboard configurations, and may be designed with a housing mold of an identical specification with regard to various product models of different keyboard configurations, so as to achieve the objectives of reducing manufacturing and inventory costs.

### BRIEF DESCRIPTION OF DRAWINGS

The invention can be more fully understood by reading the following detailed description of the preferred embodiments, with reference made to the accompanying drawings, wherein:

FIG. 1 provides a functional block diagram of a touch screen palm-type data processing device of an embodiment according to the present invention;

FIG. 2A shows a keyboard configuration displayed by a key touch control display unit of the touch screen palm-type data processing device shown in FIG. 1;

FIG. 2B shows another keyboard configuration displayed by a key touch control display unit of the touch screen palm-type data processing device shown in FIG. 1;

FIG. 3A provides a front view of an embodiment of a touch screen palm-type data processing device; and

FIG. 3B is a front view of another embodiment of a touch screen palm-type data processing device.

### DETAILED DESCRIPTION OF PREFERRED EMBODIMENTS

The following illustrative embodiments are provided to illustrate the disclosure of the present invention and its advantages, these and other advantages and effects being readily understood by those in the art after reading the disclosure of this specification. The present invention can also be performed or applied by other embodiments. The details of the specification are based on specific features and applications, but numerous modifications and variations can be devised without departing from the spirit of the present invention.

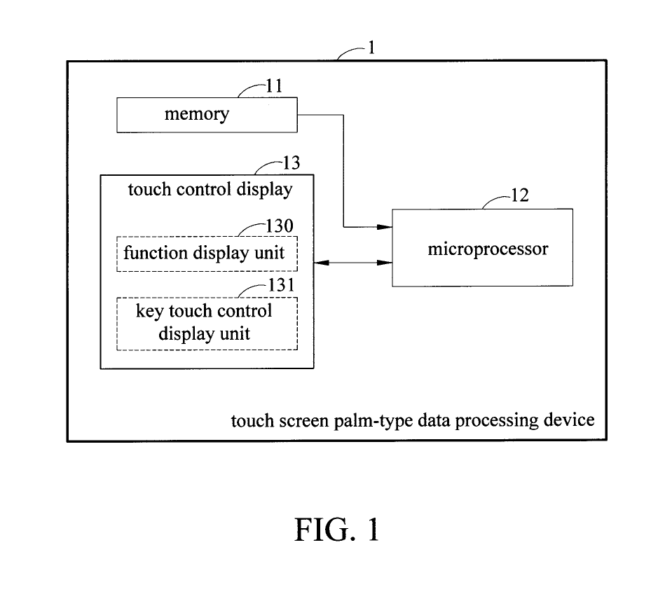

FIG. 1 is a functional block diagram of a touch screen palm-type data processing device 1 of an embodiment according to the present invention. The touch screen palm-type data processing device 1 may be a cellular phone, personal digital assistant (PDA), GPS navigation device or palm-type computer. The touch screen palm-type data processing device 1 comprises a memory 11, a microprocessor 12, a function display unit 130 and a key touch control display unit 131.

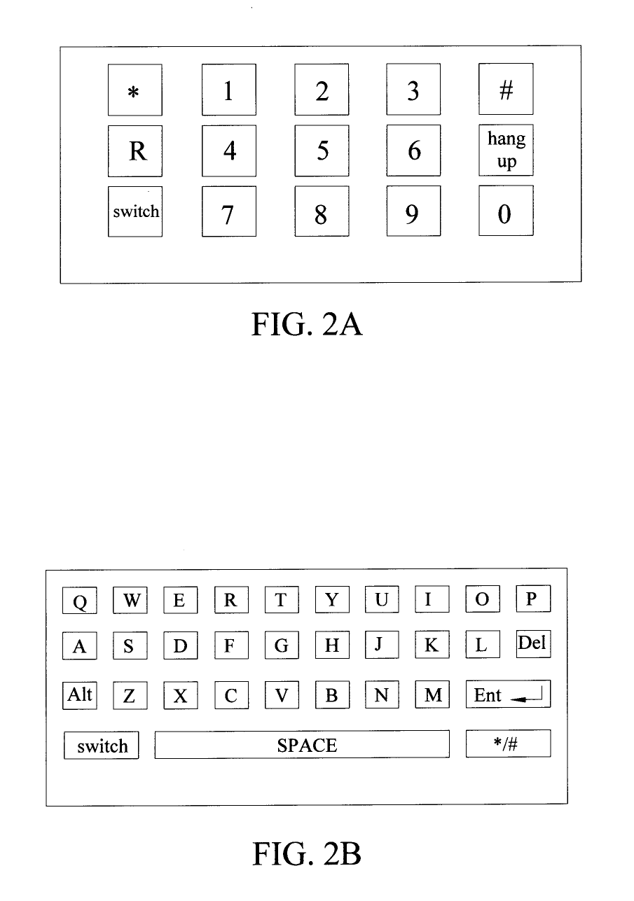

The memory 11 is electrically connected to the microprocessor 12, and is stored with an operation program and a function program. The operation program, when executed by the microprocessor 12, displays a keyboard configuration for a user to input data thereon. The function program, when executed by the microprocessor 12, provides a processing function. The preset keyboard configuration is exemplified with a numeric type keyboard that is composed of ten numeric keys (0-9) and a plurality of function keys, as shown in FIG. 2A, or with a QWERTY keyboard that comprises the 26 English alphabetical letters (A-Z) and a plurality of function keys, as shown in FIG. 2B. The operation program, when executed by the microprocessor 12, displays a desired keyboard configuration. The function program is designed according to the functions provided by the touch screen palm-type data processing device 1. For example, if the touch screen palm-type data processing device 1 has a cellular phone communication function, the function program may be a process that enables the microprocessor 12 to dial/answer the phone. Alternatively, if the touch screen palm-type data processing device 1 has a goods checking function, the function program is a process that enables the microprocessor 12 to start a scanner and execute a barcode reading, identifying and storing process.

As embodied in FIG. 1, the function display unit 130 and the key touch control display unit 131 are contained in a single touch control display 13. The touch control display 13 is electrically connected to the microprocessor 12. The function display unit 130, after the microprocessor 12 executes the function program stored in the memory 11, displays a processing function picture corresponding to the function program, such that a user may determine the functional processes that the device 1 provides. The key touch control display unit 131, after the microprocessor 12 executes the operation program stored in the memory 11, displays a preset keyboard configuration corresponding to the operation program, such that the user may control the execution of the functional process displayed by the function display unit 130 according to the preset keyboard configuration displayed by the key touch control display unit 131.

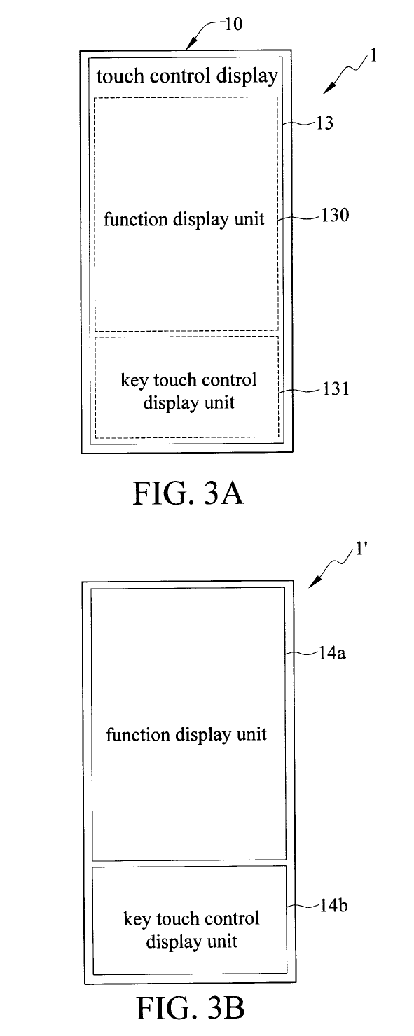

FIG. 3A is a front view of an embodiment of the touch screen palm-type data processing device. A touch control display 13 is installed in a housing 10 of the touch screen palm-type data processing device 1, and constitutes the function display unit 130 and the key touch control display unit 131.

FIG. 3B is a front view of another, embodiment of a touch screen palm-type data processing device 1′. The function display unit 130 and the key touch control display unit 131 (both unlabeled) are contained in two touch control displays 14a and 14b, respectively. Alternatively, the touch control display 14a may be replaced by a liquid crystal display (not shown).

With the key touch control display unit 131, the touch screen palm-type data processing device may meet the requirements of clients for different keyboard configurations and provide required keys displaying content customized for a particular function to be manipulated by the user. Since the keyboard configuration of the device has a single specification only, the device is more easily manufactured, and solves the problem of requiring much stock for the accessories to be held in inventory.

In yet another embodiment, a touch screen palm-type data processing device of the present invention further comprises a selection unit (not shown), and the above-mentioned memory is stored with a plurality of operation programs that may, when executed, display different keyboard configurations, such that a user may manipulate the selection unit to select one of the keyboard configurations stored in the memory, and the touch screen palm-type data processing device is prompted to display the keyboard configuration selected by the user and provides an operation interface for the user. In an embodiment, the selection unit is a mechanical key that is electrically connected to the microprocessor and may be installed on a side of the housing 10, such that the user may easily manipulate the mechanical key. In another embodiment, the selection unit is a touch key that is displayed in the key touch control display unit. As exemplified in FIGS. 2A and 2B, the touch key may be the switch key on the bottom-left corner.

With the selection unit that may be the physical keys on the device housing or virtual keys on the touch control display, the touch screen palm-type data processing device of the present invention may select a keyboard configuration that is needed for a particular usage, making the selection of the keyboard configuration more flexible.

In summary, the touch screen palm-type data processing device comprises an operation program that is stored in the memory for displaying a preset keyboard configuration. Thereby, the device can meet the requirements of a user for the keyboard configuration and display a required keyboard configuration. Thus, a device manufacturer, when facing the requirements of various customer groups for different keyboard configurations, may manufacture different keyboard configurations using an identical product specification, by the use of the device. Accordingly, the inventions addresses the problems of the prior art, wherein different corresponding molds have to be designed to address various keyboard configurations, various physical keys of different display symbols have to be bought to address different languages, the production efficiency is reduced, the accessories are not in common use, and the stock is hard to manage.

The foregoing descriptions of the detailed embodiments are illustrated to disclose the features and functions of the present invention and are not intended to be restrictive of the scope of the present invention. It should be understood by those in the art that many modifications and variations can be made according to the spirit and principles in the disclosure of the present invention and yet still fall within the scope of the appended claims.

What is claimed is:

1. A touch screen palm-type data processing device, comprising:
a microprocessor;
a memory electrically connected to the microprocessor and stored with an operation program and a function program, the operation program, when executed by the microprocessor, displaying a keyboard configuration for a user to input data thereon, the function program, when executed by the microprocessor, providing a processing function;
a function display unit electrically connected to the microprocessor and used for displaying a processing function picture after the microprocessor executes the function program; and
a key touch control display unit electrically connected to the microprocessor and used for displaying a keyboard configuration after the microprocessor executes the operation program.

2. The touch screen palm-type data processing device of claim 1, wherein the keyboard configuration comprises a numeric type keyboard or a QWERTY keyboard.

3. The touch screen palm-type data processing device of claim 1, wherein the memory is further stored with another operation program, which, when executed by the microprocessor, displays another keyboard configuration different from the existing keyboard configuration, such that the microprocessor selectively executes one of the operation program and the another operation program and the key touch control display unit displays the keyboard configuration or the another keyboard configuration depending on execution of the operation program or the another operation program by the microprocessor.

4. The touch screen palm-type data processing device of claim 3, further comprising a mechanical key electrically connected to the microprocessor, allowing the user to press and select one of the keyboard configuration and the another keyboard configuration, such that the microprocessor executes one of the operation program and the another operation program corresponding to the selected one of the keyboard configuration and the another keyboard configuration, and the key touch control display unit displays the selected one of the keyboard configuration and the another keyboard configuration.

5. The touch screen palm-type data processing device of claim 3, further comprising a touch key that is displayed in the key touch control display unit, allowing the user to touch and select one of the keyboard configuration and the another keyboard configuration, such that the microprocessor executes one of the operation program and the another operation program corresponding to the selected one of the keyboard configuration and the another keyboard configuration, and the key touch control display unit displays the selected one of the keyboard configuration and the another keyboard configuration.

6. The touch screen palm-type data processing device of claim 1, wherein the function display unit and the key touch control display unit are contained in a single touch control display.

7. The touch screen palm-type data processing device of claim 1, wherein the function display unit and the key touch control display unit are contained in two touch control displays, respectively.

8. The touch screen palm-type data processing device of claim 1, wherein the function display unit is contained in a display screen, and the key touch control display unit is contained in a touch control display.
